(19) United States
(12) Patent Application Publication
(10) Pub. No.: US 2025/0321378 A1
(43) Pub. Date: Oct. 16, 2025

(54) CASCADED PHOTONIC FILTERS AND RELATED DEVICES

(71) Applicant: General Dynamics Mission Systems, Inc., Fairfax, VA (US)

(72) Inventors: David L.K. Eng, Westfield, NJ (US); Bhaskar S. Abhiraman, Morristown, NJ (US); Allen Yang, Whippany, NJ (US)

(73) Assignee: General Dynamics Mission Systems, Inc., Fairfax, VA (US)

(21) Appl. No.: 18/634,146

(22) Filed: Apr. 12, 2024

(51) Int. Cl. G02B 6/293

(52) U.S. Cl. CPC G02B 6/29343

(57) ABSTRACT

Apparatus are provided for photonic filters for photonic integrated circuits or other optical devices. A photonic filter includes a first waveguide for an optical signal, a first filtering arrangement proximate the first waveguide, an intermediate waveguide offset from the first filtering arrangement in a first direction, a second filtering arrangement offset from the intermediate waveguide in the first direction and offset from the first filtering arrangement in a second direction perpendicular to the first direction, and a second waveguide offset from the second filtering arrangement in the first direction for a second optical signal influenced by the optical signal. The first filtering arrangement includes oblong rings disposed between the first waveguide and the intermediate waveguide, and the second filtering arrangement includes oblong rings between the intermediate waveguide and the second waveguide. The rings include Euler bends and are configured to achieve the Vernier effect.

### TECHNICAL FIELD OF THE INVENTION

The subject matter described herein relates generally to optical communications systems, and more particularly, embodiments of the subject matter relate to optical devices with wavelength multiplexers or demultiplexers using cascaded photonic filters that exhibit the Vernier effect for increased free spectral range (FSR).

### BACKGROUND OF THE INVENTION

This section provides background information related to the present disclosure which is not necessarily prior art.

Optical telecommunication systems typically include discrete components that perform various optical functions, such as, for example, modulation, demodulation, multiplexing, demultiplexing, and the like. Photonic integrated circuits (PICs) have been developed that incorporate optical components, such as waveguides, filters and the like, into a packaged optical or electro-optical devices or chip, rather than reliance on larger discrete fiber optic components. This allows for more complex optical or electro-optical systems to be packaged into a smaller form factor to suit a variety of different applications.

For telecommunications applications, it is typically desirable to maximize the channel density or number of discrete communication channels over a given range of wavelengths or frequencies while also being able to maintain channel separation to avoid crosstalk. Filters, such as optical ring resonators, are utilized to pass light of specific wavelengths while rejecting others. However, ring resonators can exhibit periodicity and pass additional wavelengths within the bandwidth of interest due to their limited free spectral range (FSR), which potentially leads to crosstalk or other interference. The periodicity of an optical ring resonator is inversely proportional to the circumference of the ring resonators, but reducing the size of ring resonators can increase losses due to leakage from bending light too sharply.

Accordingly, it is desirable to increase the FSR of photonic filters to improve performance while reducing the area required to improve form factor. Other desirable features and characteristics will become apparent from the subsequent detailed description and the appended claims, taken in conjunction with the accompanying drawings and the foregoing technical field and background.

### SUMMARY OF THE INVENTION

This section provides a general summary of the disclosure and is not a comprehensive disclosure of its full scope or all of its features.

Apparatus are provided for photonic filters for photonic integrated circuits or other optical devices.

An exemplary optical device includes a photonic filter having a first waveguide to receive an optical signal, a first filtering arrangement proximate the first waveguide, an intermediate waveguide offset from the first filtering arrangement in a first direction, a second filtering arrangement offset from the intermediate waveguide in the first direction and offset from the first filtering arrangement in a second direction perpendicular to the first direction, and a second waveguide offset from the second filtering arrangement in the first direction for a second optical signal influenced by the optical signal. The first filtering arrangement includes a first oblong ring offset from the first waveguide in the first direction and a second oblong ring offset from the first oblong ring in the first direction, wherein the first oblong ring is disposed between the first waveguide and the second oblong ring. The second filtering arrangement includes a third oblong ring offset from the intermediate waveguide in the first direction, wherein the intermediate waveguide is disposed between the second oblong ring and the third oblong ring, and a fourth oblong ring offset from the third oblong ring in the first direction, wherein the third oblong ring is disposed between the intermediate waveguide and the fourth oblong ring and the fourth oblong ring is disposed between the third oblong ring and the second waveguide.

In another implementation, an apparatus for a photonic filter is provided. The photonic filter includes a first waveguide having an input end to receive a broadband optical signal and a through port end opposite the input end for a through port optical signal including a subset of communications channels of a plurality of communications channels contained in the broadband optical signal, a first filtering arrangement offset from the first waveguide in a filtering direction substantially perpendicular to the first waveguide, wherein the first filtering arrangement includes a first set of Euler rings, an intermediate waveguide offset from the first filtering arrangement in the filtering direction, wherein the first filtering arrangement is disposed between the first waveguide and the intermediate waveguide, a second filtering arrangement offset from the intermediate waveguide in the filtering direction, wherein the second filtering arrangement includes a second set of Euler rings and the intermediate waveguide is disposed between the first filtering arrangement and the second filtering arrangement, and a second waveguide offset from the second filtering arrangement in the filtering direction and having a drop port end for a drop port optical signal including one or more communications channels of the plurality of communications channels.

In another implementation, an apparatus for a photonic filter is provided that includes a first waveguide having an input end to receive an input optical signal including one or more communications channels and an output end opposite the input end for an output optical signal including the one or more communications channels and an additional communications channel, a first filtering arrangement offset from the first waveguide in a filtering direction substantially perpendicular to the first waveguide, wherein the first filtering arrangement includes a first set of Euler rings, an intermediate waveguide offset from the first filtering arrangement in the filtering direction, wherein the first filtering arrangement is disposed between the first waveguide and the intermediate waveguide, a second filtering arrangement offset from the intermediate waveguide in the filtering direction, wherein the second filtering arrangement includes a second set of Euler rings and the intermediate waveguide is disposed between the first filtering arrangement and the second filtering arrangement, and a second waveguide offset from the second filtering arrangement in the filtering direction and having a second input end for a second input optical signal including the additional communications channel.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, where corresponding reference numerals indicate corresponding parts throughout the several views of the drawings. The particular choice of drawings is not intended to limit the scope of the present disclosure.

FIG. 1 depicts a block diagram of an exemplary optical device in accordance with one or more exemplary implementations;

FIG. 2 depicts a top view of an exemplary photonic filter suitable for use in the optical device of FIG. 1 in accordance with one or more implementations; and

FIG. 3 depicts a block diagram of the photonic filter of FIG. 2 depicting spectral performance of the photonic filter in a demultiplexing mode of operation in accordance with one or more implementations.

### DETAILED DESCRIPTION

The following detailed description is merely exemplary in nature and is not intended to limit the subject matter of the application and uses thereof. Furthermore, there is no intention to be bound by any expressed or implied theory presented in the preceding technical field, background, summary, or the following detailed description.

Embodiments of the subject matter described herein generally pertain to optical or electro-optical devices such as photonic integrated circuits (PICs) that include a photonic filter that includes multiple stages of filtering arrangements configured to provide a higher order filter that exhibits the Vernier effect to broaden the free spectral range (FSR) of the filter. For example, in one or more exemplary implementations, the photonic filter is realized as a fourth-order cascaded microring filter that includes optical ring resonators having different dimensions that are offset from one another in a cascaded manner to achieve the Vernier effect. Additionally, in exemplary implementations, the ring resonators incorporate Euler bends or clothoid bends or otherwise exhibit an oblong shape with continuously changing curvature that provides loss minimizing geometry by smoothly bending light along a shorter optical path length or circumference, thereby improving FSR while reducing area requirements.

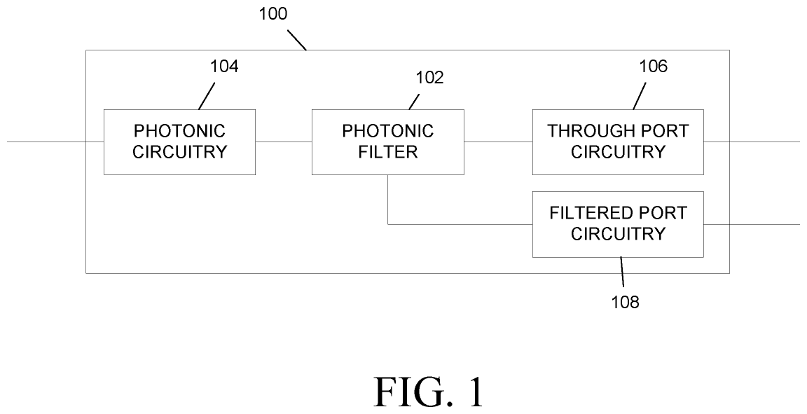

FIG. 1 depicts an exemplary optical device 100 that includes a photonic filter 102 that is disposed between photonic circuitry 104, 106, 108 coupled to the respective input/output (I/O) interfaces of the optical device 100. In exemplary implementations, the optical device 100 is realized as a photonic integrated circuit (PIC), where the photonic filter 102 and the photonic circuitry 104, 106, 108 is fabricated, formed or otherwise disposed on a semiconductor substrate that is then overmolded or otherwise encapsulated into an integrated circuit device package. In this regard, photonic circuitry 104, 106, 108 generally represents the optical ports, couplers and/or other optical components of receiving or otherwise engaging with optical fibers for transmitting optical signals to/from the optical device 100. Accordingly, for purposes of explanation, but without limitation, the optical device 100 may alternatively be referred to herein as a PIC. It should be appreciated that FIG. 1 is a simplified representation of an optical device 100 for purposes of explanation and is not intended to be limiting.

Depending on the particular application and configuration of the PIC 100, the photonic filter 102 and PIC 100 may be capable of functioning as a multiplexer or a demultiplexer. In this regard, when configured as a demultiplexer, the photonic circuitry 104 may be coupled to an optical fiber that is transmitting an input optical signal to the PIC 100 that includes a plurality of optical communications channels multiplexed into the input optical signal transmitted via the optical fiber, where the photonic filter 102 is configured to filter a respective one of the optical communications channels and output that respective optical communications channel to filtered port circuitry 108 and pass remaining ones of the optical communications channels to through port circuitry 106. On the other hand, when configured as a multiplexer, the filtered port circuitry 108 is coupled to an optical fiber that is transmitting an input optical signal to be added or multiplexed with a second input optical signal provided via the through port circuitry 106, resulting in the photonic filter 102 providing a multiplexed output optical signal via the photonic circuitry 104 that includes the communications channels that were input to the multiplexer via the respective instances of photonic circuitry 106, 108.

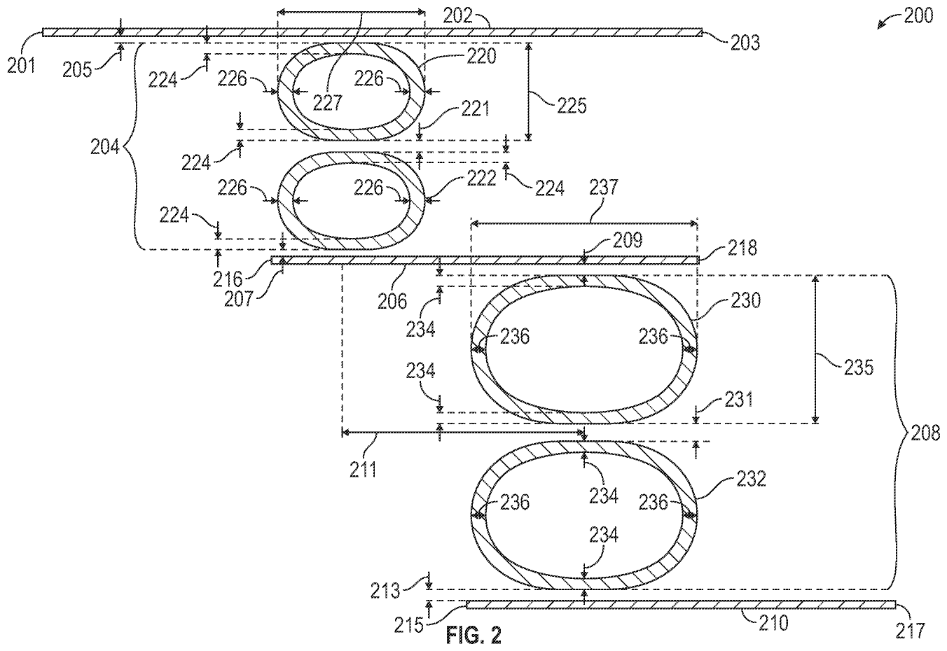

FIG. 2 depicts an exemplary implementation of a photonic filter 200 suitable for use as the photonic filter 102 in the PIC 100 of FIG. 1. The photonic filter 200 includes a first input/output (I/O) interface waveguide 202 of core material capable of transmitting optical signals between respective I/O ends 201, 203 that are optically coupled to respective instances of photonic circuitry (e.g., photonic circuitry 104, 106), and for purposes of explanation, the first waveguide 202 may alternatively be referred to herein as the through waveguide 202. A first ring resonator filtering arrangement 204 of core material is offset from the through waveguide 202 by a coupling gap distance 205 in a direction that is substantially perpendicular to a longitudinal axis of the through waveguide 202. For purposes of explanation, the direction aligned substantially perpendicular to the longitudinal axis of the through waveguide 202 may alternatively be referred to herein as the filtering direction, with the direction aligned substantially parallel to the longitudinal axis of the through waveguide 202 may alternatively be referred to herein as the transmission direction.

An intermediate waveguide 206 of core material is offset from the first ring resonator filtering arrangement 204 by a coupling gap distance 207 in the filtering direction, and a second ring resonator filtering arrangement 208 of core material is offset from the intermediate waveguide 206 by a second coupling gap distance 209 in the filtering direction. Additionally, the geometric center of the second ring resonator filtering arrangement 208 is laterally offset from the geometric center of the first ring resonator filtering arrangement 204 in the transmission direction by a lateral offset distance 211 that provides thermal isolation between the first ring resonator filtering arrangement 204 and the second ring resonator filtering arrangement 208 to support independently tuning or biasing one or more of the ring resonator filtering arrangements 204, 208 by heating the respective ring resonator filtering arrangement 204, 208. For example, in some implementations, the lateral thermal isolation offset distance 211 is greater than or equal to 600 micrometers (or microns) to prevent thermal crosstalk. The length of the intermediate waveguide 206 in the transmission direction is greater than the sum of the widths of the respective filtering arrangements 204, 208 to encompass the lateral offset distance 211 and extend from the lateral extent of the first ring resonator filtering arrangement 204 to the opposing lateral extent of the second ring resonator filtering arrangement 208. Another I/O waveguide 210 is offset from the second ring resonator filtering arrangement 208 by a coupling gap distance 213 in the filtering direction for transmitting an optical signal between an end 215 proximate the second ring resonator filtering arrangement 208 and an opposing I/O end 217 that is optically coupled to photonic circuitry (e.g., filtered port circuitry 108). As shown, in exemplary implementations, a lateral extent of the end 215 of the distal to the I/O end 217 in the transmission direction corresponds to a lateral extent of the second ring resonator filtering arrangement 208 such that the I/O waveguide 210 overlaps the lateral extents of the second ring resonator filtering arrangement 208 in the filtering direction, where lateral extents 216, 218 of the intermediate waveguide 206 are configured to overlap the lateral extents of both of the respective ring resonator filtering arrangements 204, 208 in the filtering direction.

Referring to FIG. 2 with reference to FIG. 1, when configured as a demultiplexer, an input end 201 of the through waveguide 202 is optically coupled to the photonic circuitry 104 to receive a multiplexed input optical signal at the input end 201 that includes multiple communications channels, and the interface end 217 of the waveguide 210 is coupled to the filtered port circuitry 106 for transmitting the filtered communications channel at the particular wavelength the ring resonator filtering arrangements 204, 208 are configured to resonate and thereby filter from the multiplexed input optical signal, with the output end 203 of the through waveguide 202 transmitting an optical signal that includes those non-resonant wavelength communications channels that are not filtered by the filtering arrangements 204, 208. In alternative implementations, when configured as a multiplexer, an input end 217 of the I/O waveguide 210 is optically coupled to the filtered port circuitry 106 for receiving an optical signal having a resonant wavelength of the ring resonator filtering arrangements 204, 208 to be multiplexed with another optical signal received at the input end 203 of the through waveguide 202, resulting in a multiplexed output signal at the output end 201 of the through waveguide 202 that includes the optical communications channel that was input at the input end 217 of the I/O waveguide 210.

In exemplary implementations, the first ring resonator filtering arrangement 204 is configured as a second-order ring resonator that includes a first ring 220 of core material offset from the through waveguide 202 by a resonator coupling gap distance 205 in the filtering direction and a second ring 222 of core material offset from the first ring 220 by an intermediate ring coupling gap distance 221 in the filtering direction. In the illustrated implementation, the intermediate ring coupling gap distance 221 is greater than the resonator coupling gap distance 205. In some implementations, the ratio of the intermediate ring coupling gap distance 221 to the resonator coupling gap distance 205 is greater than about 2.5. For example, to filter an optical communications channel having a center wavelength in the range of 1530 nanometers (nm) to 1565 nm and a channel width of 0.4 nm, the intermediate ring coupling gap distance 221 may be in the range of 250-450 nm and the resonator coupling gap distance 205 may be in the range of 110-140 nm. For example, in one implementation, the intermediate ring coupling gap distance 221 is 350 nm and the resonator coupling gap distance 205 is 137 nm. In exemplary implementations, the resonator coupling gap distance 207 between the second Euler ring 222 and the intermediate waveguide 206 is substantially equal to the resonator coupling gap distance 205 between the through waveguide 202 and the first Euler ring 220.

In exemplary implementations, the rings 220, 222 have Euler bends or are otherwise configured in an oblong or clothoid shape with continuously changing curvature that is capable of minimizing losses by smoothly bending light along a shorter optical path length or circumference to improve FSR while reducing distance occupied by the first ring resonator filtering arrangement 204 in the filtering direction, thereby reducing the area required for the first ring resonator filtering arrangement 204 to achieve a desired FSR for a particular wavelength of interest. To achieve an Euler ring having Euler bend geometry, the curvature at a respective location along the optical path varies linearly with respect to the arc length as the arc length increases from a point along the ring 220 that is closest to through waveguide 202 or a point closest to the second ring 222 and having the narrowest cross-sectional width 224 and least amount of curvature towards a location on the ring 220 farthest from the through waveguide 202 or adjacent ring 222 having a largest cross-sectional width 226 and greatest amount of curvature. The resulting shape of the Euler ring 220 is that of an oblong ring whose curvature is varied continuously along the arc in a manner that is configured to minimize optical path length and bending loss, where the cross-sectional width of the core material is proportionally or directly related to the curvature (e.g., width increases as curvature increases and vice versa). In exemplary implementations, the shape and configuration of the second ring 222 is substantially identical to the first ring 220, such that the rings 220, 222 are symmetrical Euler rings that have the same optical path lengths and exhibit substantially the same resonance characteristics. For example, each of the rings 220, 222 may be constructed by arranging identical 90° arcs that are rotated and shifted accordingly to provide a continuous arcuate optical path exhibiting a clothoid shape.

In a similar manner, in exemplary implementations, the second ring resonator filtering arrangement 208 is also configured as a second-order ring resonator that includes a first Euler ring 230 of core material offset from the intermediate waveguide 206 by a resonator coupling gap distance 209 in the filtering direction and a second Euler ring 232 of core material offset from the first Euler ring 230 by an intermediate ring coupling gap distance 231 in the filtering direction. In this regard, by virtue of the configuration of the filtering arrangements 204, 208 as cascaded second-order filters, the photonic filter 200 illustrated in FIG. 2 corresponds to a fourth-order filter. Similar to the first ring resonator filtering arrangement 204, the intermediate ring coupling gap distance 231 is greater than the resonator coupling gap distance 209, and the ratio of the intermediate ring coupling gap distance 231 to the resonator coupling gap distance 209 is greater than 2. For example, to filter an optical communications channel having a center wavelength in the range of 1530 nm to 1565 nm and a channel width of 0.4 nm, the intermediate ring coupling gap distance 221 may be in the range of 300 nm to 400 nm and the resonator coupling gap distance 205 may be in the range of 120 nm to 180 nm.

In exemplary implementations, the second filter stage Euler rings 230, 232 also have Euler bends to provide a clothoid shape with continuously changing curvature, where the curvature at a respective location along the optical path varies linearly with respect to the arc length as the arc length increases from a point along the ring 230, 232 that is closest to a waveguide 206, 210 or the other ring 230, 232 and having the narrowest cross-sectional width 234 and least amount of curvature towards a respective location on the ring 230, 232 having a largest cross-sectional width 236 and greatest amount of curvature, where the shape and configuration of the rings 230, 232 are substantially symmetrical, have the same optical path lengths and exhibit substantially the same resonance characteristics. In one more implementation, the optical path length of the second filter stage Euler rings 230, 232 is greater than the optical path length of the first filter stage Euler rings 220, 222, which increases the FSR associated with the through waveguide 202. Additionally, in exemplary implementations, the respective optical path lengths are configured such that the photonic filter 200 exhibits the Vernier effect to increase the FSR of the filter 200, for example, by making the ratio of the optical path length (m1) of the first stage Euler rings 220, 222 to the optical path length (m2) of the second stage Euler rings 230, 232 equal to a ratio of two coprime integers (e.g., m1/m2=2/3, 3/5, 5/7, etc.). For example, in one implementation, the first stage filter Euler rings 220, 222 are configured to achieve an optical path length of 8π μm within a lateral distance 227 in the transmission direction of about 10 μm or less where each Euler ring 220, 222 occupies a distance 225 in the filtering direction of 7 μm or less, and the second stage filter Euler rings 230, 232 are configured to achieve an optical path length of 12π μm within a lateral distance 237 in the transmission direction of about 15 μm or less where each Euler ring 230, 232 occupies a distance 235 in the filtering direction of 9 μm or less.

In practice, the narrowest cross-sectional width 224 influences the coupling between rings 220, 222, such that reducing the cross-sectional width 224 may allow one or more of the coupling gap distances 205, 221 to be reduced, and thereby reduce the area of the photonic filter 200. For example, in some implementations, the area of the photonic filter 200 may be less than 0.05 mm². In exemplary implementations, the intermediate ring coupling gap distance 221 is chosen to achieve a desired power coupling ratio (e.g., the fraction of light that crosses the gap distance 221) with respect to the power coupling ratio of distance 205 in accordance with the equation

$$k ( {d}_{i} ) = \frac{{k ( {d}_{r} )}^{2}}{4} ,$$

where dᵢ is the intermediate ring coupling gap distance 221, dᵣ is the resonator coupling gap distance 205 and k is the power coupling fraction as a function of gap distance. In a similar manner, the coupling gap distances 209, 231 are configured to achieve a desired power coupling ratio for the second stage filter including Euler rings 230 and 232. As illustrated in FIG. 2, in exemplary implementations, the coupling gap distance 221 between the first stage Euler rings 220, 222 is greater than the resonator coupling gap distances 205, 207 associated with the first stage, and the coupling gap distance 231 between the second stage Euler rings 230, 232 is greater than the resonator coupling gap distances 209, 213 associated with the second stage, with the respective second stage coupling gap distances 209, 213, 231 being greater than their respective counterpart first stage coupling gap distances 205, 207, 221.

To achieve the desired Vernier effect, the effective optical paths lengths of the respective stages are tuned to provide a desired coprime ratio, where the respective optical path lengths correspond to the circumference of the respective Euler rings of the respective stage of the photonic filter 200 multiplied by the effective refractive index. However, in practice the effective refractive index is influenced by the bending radius, such that the respective filter stages have slightly difference effective refractive indices. In this regard, to reduce thermal heating or tuning requirements, the effective refractive indices may be measured or otherwise determined and utilized to correspondingly adjust the circumferences of the respective Euler rings to achieve the desired coprime ratio, and thereby, the desired Vernier effect with reduced power usage or other tuning requirements (e.g., asymmetrical heating of one of the filter stages).

Referring to FIGS. 1-2, in exemplary implementations, in a demultiplexing mode of operation, a broadband optical signal input to an input end 201 of the through waveguide 202 (e.g., via photonic circuitry 104 coupled to an optical fiber) is demultiplexed into an optical signal embodying a subset of one or more individual communications channels contained within the input broadband optical signal at a drop port output end 217 of the drop port waveguide 210, where the filtered communications channel(s) at the drop port output end 217 are dictated or otherwise defined by the shape and configuration of the filtering arrangements 204, 208 and the attendant Vernier effect. An output broadband optical signal is also provided at a through port output end 203 of the through waveguide 202 that includes the remaining communications channels of the input broadband optical signal less the filtered communications channel(s) at the drop port output end 217.

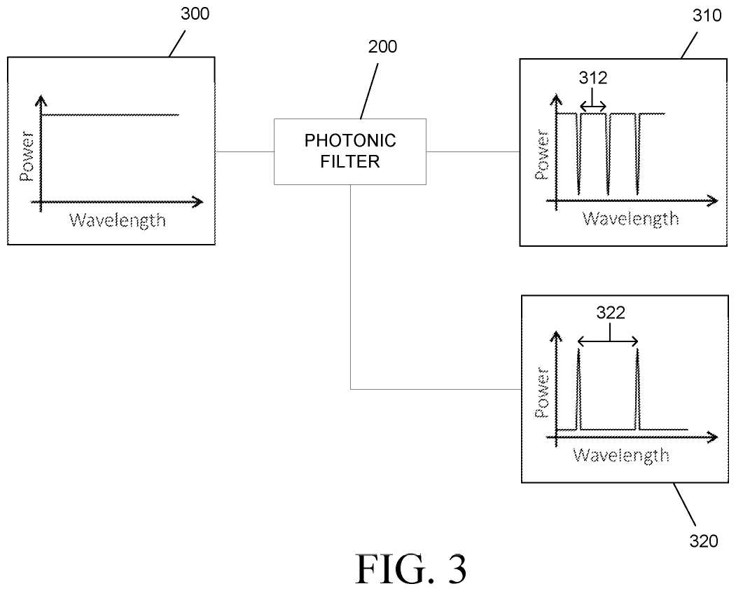

When configured as a demultiplexer, the coupling gap distances 205, 207, 209, 213, 221, 231 are configured to account for the Euler bend geometry and optimize narrowband power transfer. For example in one implementation, the rings 220, 222, 230, 232 are configured to provide a drop port 3 dB bandwidth at the output end 217 of the filtered output waveguide 210 that is less than 50 gigahertz (GHz) (or an output channel width that is 0.4 nanometers (nm) or less) and a drop port insertion loss less than 5 decibels (dB) for wavelengths in the optical C-band (e.g., wavelengths between 1530 nm to 1565 nm). In this regard, FIG. 3 depicts the relationship between the power spectrum 300 of the broadband input optical signal, the power spectrum 310 of the through port output optical signal, and the corresponding power spectrum 320 of the drop port output optical signal. By virtue of the fourth-order cascaded configuration with Euler rings configured to exhibit the Vernier effect, the photonic filter 200 is capable of achieving an FSR 312 at the through port output end 203 (e.g., the spectral range of the channels removed from the through port output end 203) of greater than 20 nm and an FSR 322 at the drop port output end 217 (e.g., the spectral range between adjacent communications channels that are transmitted via the drop port output end 217) of greater than 40 nm for wavelengths near the optical C-band.

Referring again to FIGS. 1-2, in a multiplexing mode of operation (e.g., optical signals being transmitted from right to left), an input optical signal including one or more communications channels to be added or multiplexed is input to an input end 217 of the waveguide 210 (e.g., via filtered port circuitry 108 coupled to an optical fiber), and another optical signal including one or more existing communications channels is input to an input end 203 of the through waveguide 202 (e.g., via through port circuitry 106 coupled to an optical fiber). The resulting broadband optical output signal at the output end 201 of the through waveguide 202 includes the one or more communications channels embodied by input optical signal at the input end 217 of the waveguide 210 multiplexed or added to the existing communications channel(s) input to the input end 203 of the through waveguide 202.

It should be appreciated that although the operation and configuration of the photonic filter 200 may be described herein in the context of a demultiplexer or multiplexer for purposes of explanation, in practice, the photonic filter 200 may be implemented and function in an equivalent manner in a range of different potential filtering applications, and accordingly, the subject matter described herein is not intended to be limited to demultiplexing or multiplexing.

Although not illustrated in FIG. 2, one skilled in the art will appreciate that the gaps or space between depicted regions of core material may be filled or otherwise occupied by a cladding material having a lower refractive index than the core material to facilitate containing the optical signals being transported within the core material. For example, in one implementation, the waveguides 202, 206, 210 and rings 220, 222, 230, 232 may be etched or otherwise patterned into a silicon substrate, removing surrounding areas of silicon and leaving narrow strips as the core waveguiding material. These silicon waveguides are then coated in silicon dioxide or other suitable cladding material that provides sufficient optical refractive index contrast to support waveguiding, resulting in the photonic filter 200 fabricated on the semiconductor substrate that may then be overmolded or otherwise encapsulated into a semiconductor device package, such as PIC 100. As will be appreciated in the art, based on the dimensions of the coupling gap distances 205, 207, 209, 213, 221, 231 and the optical path lengths of the rings 220, 222, 230, 232, selected frequencies of optical signals are effectively transmitted across the rings 220, 222, 230, 232 in the filtering direction through the evanescent field or evanescent wave coupling while being inhibited from transmission in the transmission direction by virtue of destructive interference caused by arcuate or circular closed paths defined by the rings 220, 222, 230, 232.

To support thermally tuning the resonance or otherwise biasing the filtering arrangements 204, 208, one or more electrical components (e.g., resistors, transistors, or the like) may be fabricated or otherwise disposed on the semiconductor substrate proximate a respective one of the filtering arrangements 204, 208, with corresponding routing and input/output (I/O) pins, contacts or other interfaces on the semiconductor device package that allow the electrical components to be independently operated to heat the respective one of the filtering arrangements 204, 208 to achieve the desired resonance characteristics. As described above, the lateral thermal separation distance 211 inhibits thermal crosstalk between the filtering arrangements 204, 208 such that heating of one of the filtering arrangements 204, 208 does not influence the resonance characteristics of the other one of the filtering arrangements 204, 208.

For the sake of brevity, conventional techniques related to ring resonators, fiber optics, multiplexing and/or demultiplexing, semiconductor device fabrication, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An optical device including a photonic filter, the photonic filter comprising:
a first waveguide to receive an optical signal;
a first filtering arrangement proximate the first waveguide, wherein the first filtering arrangement comprises:
a first oblong ring offset from the first waveguide in a first direction; and
a second oblong ring offset from the first oblong ring in the first direction, wherein the first oblong ring is disposed between the first waveguide and the second oblong ring;
an intermediate waveguide offset from the first filtering arrangement in the first direction;
a second filtering arrangement offset from the intermediate waveguide in the first direction and offset from the first filtering arrangement in a second direction perpendicular to the first direction, the second filtering arrangement comprising:
a third oblong ring offset from the intermediate waveguide in the first direction, wherein the intermediate waveguide is disposed between the second oblong ring and the third oblong ring;
a fourth oblong ring offset from the third oblong ring in the first direction, wherein the third oblong ring is disposed between the intermediate waveguide and the fourth oblong ring; and
a second waveguide offset from the second filtering arrangement in the first direction for a second optical signal influenced by the optical signal, wherein the fourth oblong ring is disposed between the third oblong ring and the second waveguide.

2. The optical device of claim 1, wherein at least one of the first oblong ring, the second oblong ring, the third oblong ring, and the fourth oblong ring comprises an Euler ring.

3. The optical device of claim 2, wherein the Euler ring comprises a ring of core material having a curvature that linearly varies with respect to arc length.

4. The optical device of claim 3, wherein a width of the ring of core material linearly varies with respect to arc length.

5. The optical device of claim 2, wherein the Euler ring comprises a clothoid shape.

6. The optical device of claim 1, wherein each of the first oblong ring, the second oblong ring, the third oblong ring, and the fourth oblong ring comprises an Euler ring.

7. The optical device of claim 1, wherein a first optical path length associated with the first filtering arrangement is less than a second optical path length associated with the second filtering arrangement.

8. The optical device of claim 7, wherein a ratio of the first optical path length to the second optical path length comprises a coprime integer ratio.

9. The optical device of claim 8, wherein each of the first oblong ring, the second oblong ring, the third oblong ring, and the fourth oblong ring comprises an Euler ring.

10. The optical device of claim 1, wherein:
the optical signal comprises a broadband optical signal including a plurality of communications channels having respective wavelengths between 1530 nm to 1565 nm; and
the second optical signal comprises a subset of one or more communications channels of the plurality of communications channels having a free spectral range (FSR) greater than 40 nm.

11. The optical device of claim 10, wherein a third optical signal at a through port end of the first waveguide opposite an input end receiving the broadband optical signal comprises one or more communications channels of the plurality of communications channels having a FSR greater than 20 nm.

12. The optical device of claim 10, wherein an area of the photonic filter is less than 0.05 mm².

13. The optical device of claim 1, wherein:
the optical signal comprises a broadband optical signal at an input end of the first waveguide including a plurality of communications channels having respective wavelengths between 1530 nm to 1565 nm; and
a third optical signal at a through port end of the first waveguide opposite the input end comprises one or more communications channels of the plurality of communications channels having a free spectral range (FSR) greater than 20 nm.

14. A photonic filter comprising:
a first waveguide having an input end to receive a broadband optical signal and a through port end opposite the input end for a through port optical signal comprising a subset of communications channels of a plurality of communications channels contained in the broadband optical signal;
a first filtering arrangement offset from the first waveguide in a filtering direction substantially perpendicular to the first waveguide, wherein the first filtering arrangement comprises a first set of Euler rings;
an intermediate waveguide offset from the first filtering arrangement in the filtering direction, wherein the first filtering arrangement is disposed between the first waveguide and the intermediate waveguide;
a second filtering arrangement offset from the intermediate waveguide in the filtering direction, wherein the second filtering arrangement comprises a second set of Euler rings and the intermediate waveguide is disposed between the first filtering arrangement and the second filtering arrangement; and
a second waveguide offset from the second filtering arrangement in the filtering direction and having a drop port end for a drop port optical signal comprising one or more communications channels of the plurality of communications channels.

15. The photonic filter of claim 14, wherein a first optical path length associated with the first filtering arrangement is less than a second optical path length associated with the second filtering arrangement.

16. The photonic filter of claim 15, wherein a ratio of the first optical path length to the second optical path length comprises a coprime integer ratio.

17. The photonic filter of claim 14, wherein the first filtering arrangement comprises a first second-order ring resonator and the second filtering arrangement comprises a second second-order ring resonator.

18. The photonic filter of claim 14, wherein:
the plurality of communications channels comprises a plurality of optical C-band communications channels having respective wavelengths between 1530 nm to 1565 nm; and
the drop port optical signal comprises a subset of one or more communications channels of the plurality of optical C-band communications channels having a free spectral range (FSR) greater than 40 nm.

19. The photonic filter of claim 18, the through port optical signal comprises the subset of communications channels having a FSR greater than 20 nm.

20. A photonic filter comprising:
a first waveguide having an input end to receive an input optical signal comprising one or more communications channels and an output end opposite the input end for an output optical signal comprising the one or more communications channels and an additional communications channel;
a first filtering arrangement offset from the first waveguide in a filtering direction substantially perpendicular to the first waveguide, wherein the first filtering arrangement comprises a first set of Euler rings;
an intermediate waveguide offset from the first filtering arrangement in the filtering direction, wherein the first filtering arrangement is disposed between the first waveguide and the intermediate waveguide;
a second filtering arrangement offset from the intermediate waveguide in the filtering direction, wherein the second filtering arrangement comprises a second set of Euler rings and the intermediate waveguide is disposed between the first filtering arrangement and the second filtering arrangement; and
a second waveguide offset from the second filtering arrangement in the filtering direction and having a second input end for a second input optical signal comprising the additional communications channel.
